(19) United States
(12) Patent Application Publication
(10) Pub. No.: US 2013/0130789 A1
(43) Pub. Date: May 23, 2013

(54) USER-INTERACTIVE APPLICATION FRAMEWORK FOR ELECTRONIC DEVICES

(71) Applicants: Janet Brigham, Mountain View, CA (US); Andrew Wells Bergen, Menlo Park, CA (US); Gary E. Swan, Los Altos, CA (US); Harold S. Javitz, Menlo Park, CA (US); Ruth Krasnow, Redwood City, CA (US); Lisa Jack, Palo Alto, CA (US)

(72) Inventors: Janet Brigham, Mountain View, CA (US); Andrew Wells Bergen, Menlo Park, CA (US); Gary E. Swan, Los Altos, CA (US); Harold S. Javitz, Menlo Park, CA (US); Ruth Krasnow, Redwood City, CA (US); Lisa Jack, Palo Alto, CA (US)

(73) Assignee: SRI INTERNATIONAL, Menlo Park, CA (US)

(21) Appl. No.: 13/300,472

(22) Filed: Nov. 18, 2011

(51) Int. Cl. A63F 9/24; G06Q 50/24; G06F 17/20

(52) U.S. Cl. 463/29; 706/11; 705/3; 463/42

(57) ABSTRACT

An electronic device may present to a user multiple questions, at least one of which corresponds to a health condition of the user. The electronic device may receive user input information from the user responsive to the questions presented to the user. A storage device may store the user input information. A processor may determine demographic and health behavior indicators based on the user input information. A user interface of the electronic device may present an interactive game to the user that is based on the demographic and health behavior indicators. The interactive game may pertain to the health condition of the user.

### TECHNICAL FIELD

The disclosed technology pertains to application frameworks for electronic devices, and more particularly to user-interactive mobile device applications.

### BACKGROUND

Oftentimes, the most effective solutions to widespread health problems are inaccessible to the people that need them the most. For example, governments and industries alike spend billions of dollars to develop various cost-effective approaches to any number of preventable health problems, such as those attributable to smoking and other destructive health behaviors and practices, but the people at greatest risk are often unable to afford access to such solutions. Also, while many health-related interventions have been developed for mobile platforms over the past few years, few—if any—such applications rely on an existing evidence base, have been examined for effectiveness, or offer a long-term approach.

Thus, there remains a need for a way to address these and other problems associated with the prior art.

### BRIEF DESCRIPTION OF THE DRAWINGS

FIG. 1 is a block diagram illustrating an example of a networked system in which embodiments of the disclosed technology may be implemented.

FIG. 2 illustrates an example of a machine-controlled method in accordance with certain embodiments of the disclosed technology.

FIG. 3 illustrates a first example of a sequence of questions presented to a user in accordance with certain embodiments of the disclosed technology.

FIG. 4 illustrates a second example of a sequence of questions presented to a user in accordance with certain embodiments of the disclosed technology.

FIG. 5 illustrates a third example of a sequence of questions presented to a user in accordance with certain embodiments of the disclosed technology.

FIG. 6 illustrates a first example of a machine-implemented method involving an interactive game to be presented to a user by an electronic device in accordance with certain embodiments of the disclosed technology.

FIG. 7 illustrates a second example of a machine-implemented method involving an interactive game to be presented to a user by an electronic device in accordance with certain embodiments of the disclosed technology.

FIG. 8 illustrates a third example of a machine-implemented method involving an interactive game to be presented to a user by an electronic device in accordance with certain embodiments of the disclosed technology.

### DETAILED DESCRIPTION

The most effective approach to health behavior change typically includes assessment and treatment to provide individually-tailored help. Embodiments of the disclosed technology may serve to bridge the gap between knowledge and implementation for users dealing with certain health conditions such as those resulting from smoking, for example. Applications implemented in connection with mobile devices such as tablet computing devices and smartphones, for example, may provide stop-smoking help for the estimated 46 million smokers within the United States alone, not to mention the millions of smokers elsewhere around the globe. Such applications may utilize natural language technology and, in some cases, touch-screen capabilities for user interaction. These applications may provide links to online video and text content. Optional website content support may also be provided.

Embodiments of the disclosed technology may serve to expand access to proven treatments for preventable health risks whose treatment involves health behavior change, and also make such treatments available for long-term support. Health behaviors that require change typically include, but are not limited to, smoking, physical exercise, nutrition, mental outlook and disposition, weight management, adherence to health treatments, and response to life stressors.

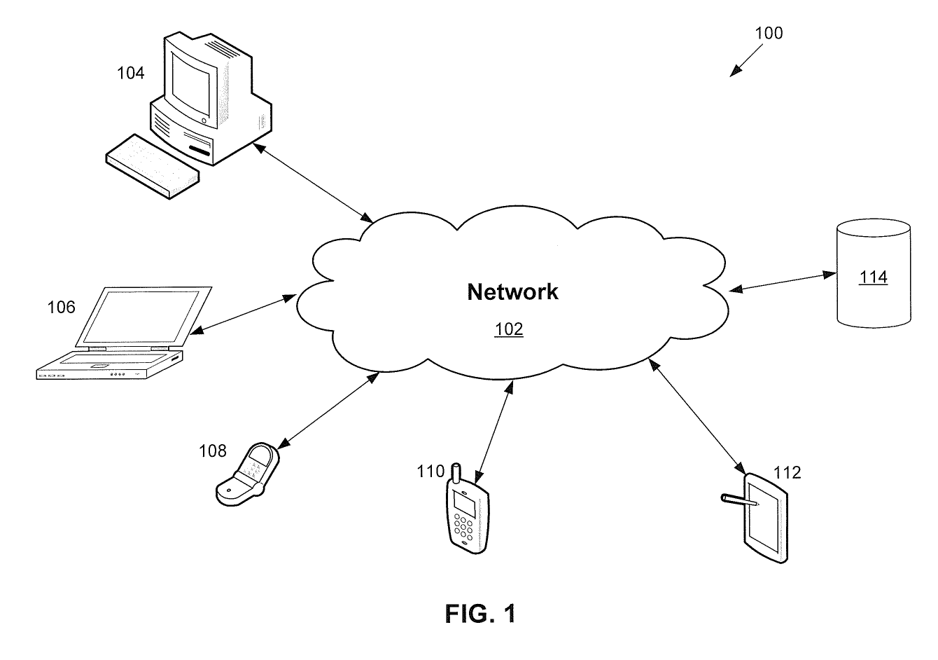

FIG. 1 is a block diagram illustrating an example of a networked system 100 in which embodiments of the disclosed technology may be implemented. In the example, the system 100 includes a network 102 such as the Internet, an intranet, a home network, or any combination thereof. Traditional computing devices such as a desktop computer 104 and laptop computer 106 may connect to the network 102 to communicate with each other or with other devices connected to the network. In the example, the networked system 100 also includes three mobile electronic devices 108-112. Two of the mobile electronic devices 108 and 110 are mobile communications devices such as cellular telephones, smartphones, or the like. The third mobile electronic device 112 is a handheld device such as a personal data assistant (PDA), tablet device, or other handheld computing device.

In the example, the networked system 100 also includes a storage device 114, which may be a central database or repository, a local data store, or a remote storage device, for example. The storage device 114 may be accessible to any or all of the other devices 104-112 over the network 10, subject to limitations or restrictions by the devices 104-112, a third party, or the storage device 114 itself. The storage device 114 may be used to store some or all of the data that is accessed and/or used by any of the computers 104 and 106 or mobile electronic devices 108-112.

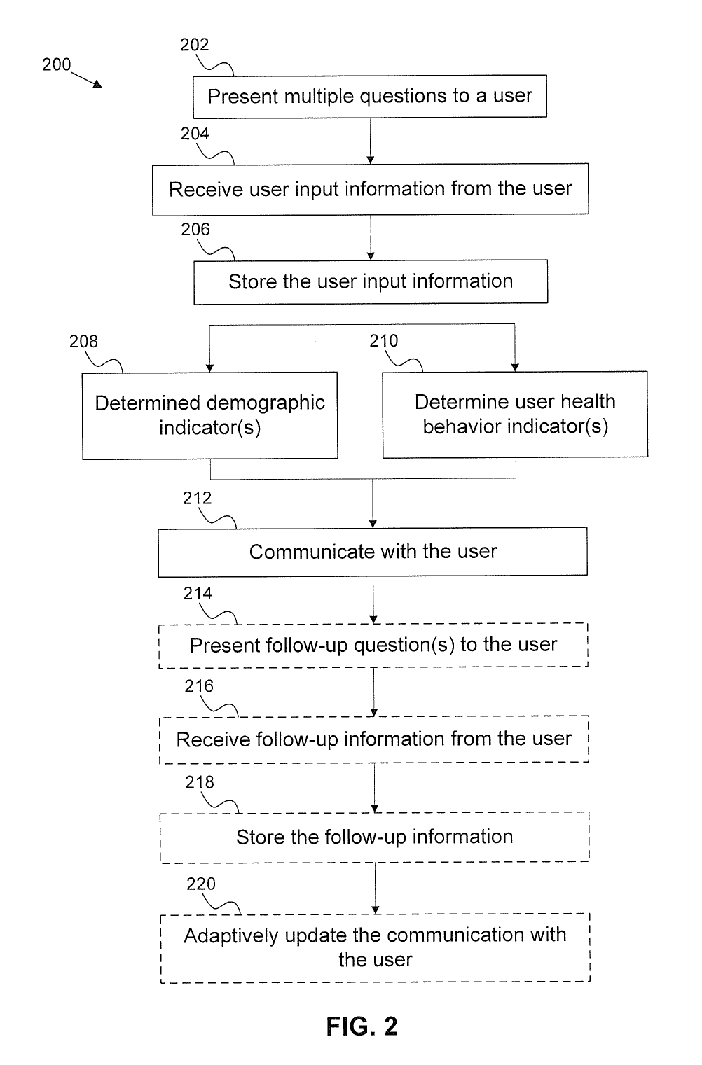

FIG. 2 illustrates an example of a machine-controlled method in accordance with certain embodiments of the disclosed technology. At 202, an electronic device, such as any of the traditional computing devices 104-106 or mobile electronic devices 108-112 of FIG. 1, presents to a user a first set of questions. The electronic device may present the questions using natural language techniques. The electronic device may present the first set of questions to the user one at a time or as a single questionnaire, for example. In certain embodiments, at least one of the questions presented to the user may pertain to physical exercise and/or weight management of the user. At least one of the first set of questions corresponds to a health condition of the user. The health condition may be an undesirable health condition, e.g., a health condition resulting from smoking or other physically destructive health behavior of the user.

At 204, the electronic device receives user input information from the user responsive to the first set of questions presented to the user. In certain embodiments, the user may respond to the questions using natural language techniques. For example, the user input information may be in the form of “yes/no” or freeform text, depending on the question(s) to which the user responds. At 206, a storage device, such as the storage device 114 of FIG. 1, stores the user input information received at 204. Alternatively or in addition thereto, the electronic device itself may store some or all of the user input information received at 204.

At 208, a processor determines at least one demographic indicator based at least in part on the user input information received at 204 and stored at 206. The demographic indicator(s) may pertain to the user's age, gender, body mass index (BMI), waist-to-hip ratio (WHR), or any combination thereof. Alternatively or in addition thereto, the demographic indicator(s) may pertain to a Fagerström Tolerance Questionnaire (FTQ) or Fagerström Test for Nicotine Dependence (FTND) score of the user, an indication as to whether the user lives with or has lived with a smoker, an indication of level of education for the user, or any combination thereof. In certain embodiments, the demographic indicator(s) determined at 208 may pertain to certain biological and/or biochemical tests performed on the user.

At 210, the processor also determines at least one user health behavior indicator based at least in part on the user input information received at 204 and stored at 206. The user health behavior indicator(s) may pertain to smoking history-related information of the user, smoking behavior-related information of the user, stress-related information of the user, depression-related information of the user, or any combination thereof. Smoking history-related information of the user may pertain to whether the user has previously given up smoking. Smoking behavior-related information of the user may pertain to how many cigarettes the user smokes each day, when the user has a first cigarette each day, how many cigarettes the user smokes early in the day compared to later in the day, whether the user smokes while ill, or any combination thereof. Depression-related information of the user may pertain to emotion-related information corresponding to the user.

In certain embodiments, the processor that determines the demographic and user health behavior indicators at 208 and 210, respectively, is a component of the electronic device that presents questions and receives user input information at 202 and 204, respectively. In other embodiments, the processor is separate from the electronic device. For example, the electronic device may be a mobile electronic device, e.g., 108-112 of FIG. 1, and the processor may be part of a traditional computing device, e.g., 104 and 106 of FIG. 1 or on a server or equivalent device.

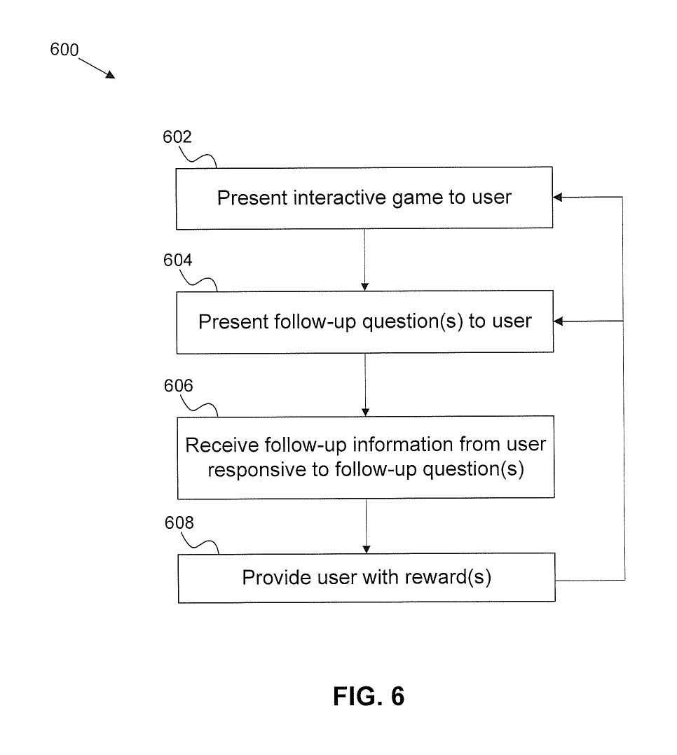

At 212, a user interface of the electronic device, such as a display or screen on a mobile electronic device, communicates with the user. This communicating is based at least in part on the demographic indicator(s) determined at 208 and the user health behavior indicator(s) determined at 210. Further, the communicating pertains to the health condition of the user. In situations where the health condition is an undesirable health condition, the communicating may correlate with at least one treatment technique associated with the undesirable health condition. In certain embodiments, the communicating includes the electronic device presenting an interactive game to the user. Examples of such an interactive game are described below with reference to FIGS. 6-8.

At 214, the electronic device may optionally present at least one follow-up question to the user and, at 216, the electronic device receives follow-up information from the user responsive to the follow-up question(s). At 218, the storage device may store the follow-up information received at 216. As with the user input information received at 204, the electronic device itself may also store some or all of the follow-up information received at 216.

At 220, the processor may adaptively update the communicating based on the follow-up information received at 216. In embodiments where the communicating at 212 includes the electronic device presenting an interactive game to the user, the adaptive updating may include increasing a difficulty level of the interactive game. In certain embodiments, the electronic device may issue a reward to the user based on the follow-up information. Such a reward may include a point-based reward, an authorization for a physical reward, an authorization for a monetary reward, or any combination thereof.

In certain embodiments, the electronic device may present to the user a second set of questions, at least one of which corresponds to a separate health condition of the user. Such embodiments may further include the electronic device receiving user input information from the user responsive to the second set of questions. As with the first set of questions presented at 202, the electronic device may present the second set of questions to the user one at a time or as a single questionnaire, for example. The storage and/or electronic device may store the user input information received by the electronic device responsive to the second set of questions. Such embodiments may also include the electronic device communicating with the user about the separate health condition. This communicating may be performed in conjunction with, or entirely separate from, the communicating at 212.

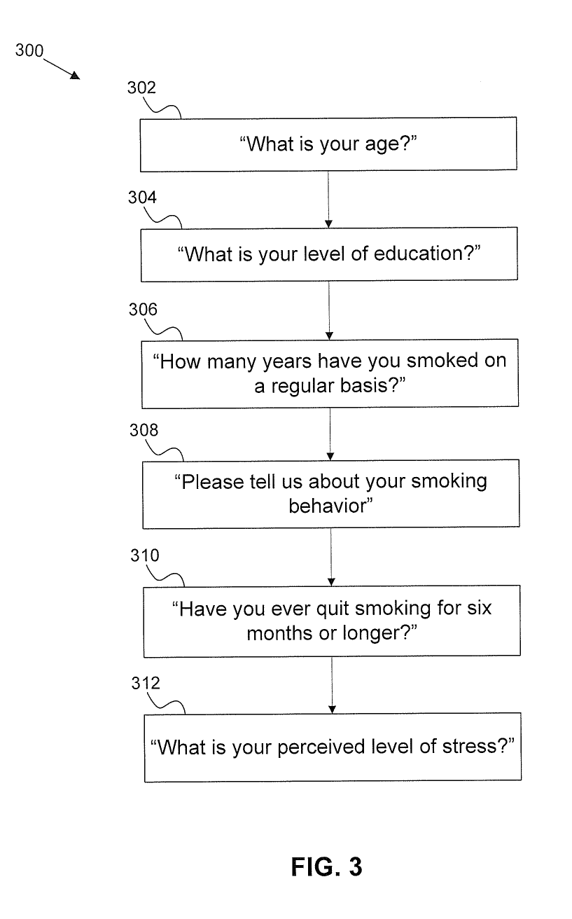

FIG. 3 illustrates a first example of a sequence of questions 300 presented to a user in accordance with certain embodiments of the disclosed technology. These questions 300 may be presented to the user by an electronic device such as occurs at 202 of FIG. 2. It will be appreciated that the illustrated set of questions 300 is but a single example of questions that may be presented to the user. Indeed, any or all of the questions 300 may be presented to a user in any given scenario. Also, the questions presented to the user may be presented in virtually any order. In certain embodiments, additional questions may be presented to the user such as questions pertaining to whether the user tends to eat in connection with his or her smoking and questions pertaining to whether he or she tends to drink alcohol and/or caffeinated beverages in connection with his or her smoking, for example.

At 302, the user is asked to provide his or her age. At 304, the user is asked to provide his or her level of education. At 306, the user is asked to indicate how many years he or she has smoked on a regular basis.

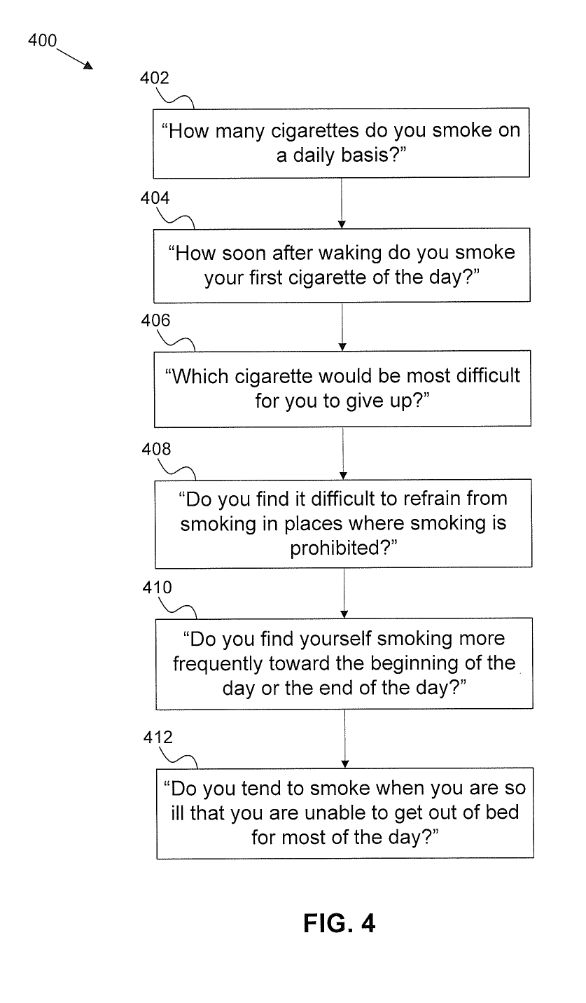

At 308, the user is asked to provide details about his or her smoking behavior. This question 308 may be presented as a single, open-ended question or it may be presented as a series of questions, such as the questions 400 of FIG. 4, described below, which are directed toward obtaining from the user specific information pertaining to the user's smoking behavior.

At 310, the user is asked to indicate whether he or she has ever quit smoking for six months or longer. Additional questions may be presented depending on the user's response. For example, if the user indicates “yes,” a subsequent question may be “Have you ever quit smoking for a year or longer?” or other period of time or, if the user indicates “no,” a subsequent question may be “Have you ever quit smoking for a week or longer?” or other period of time.

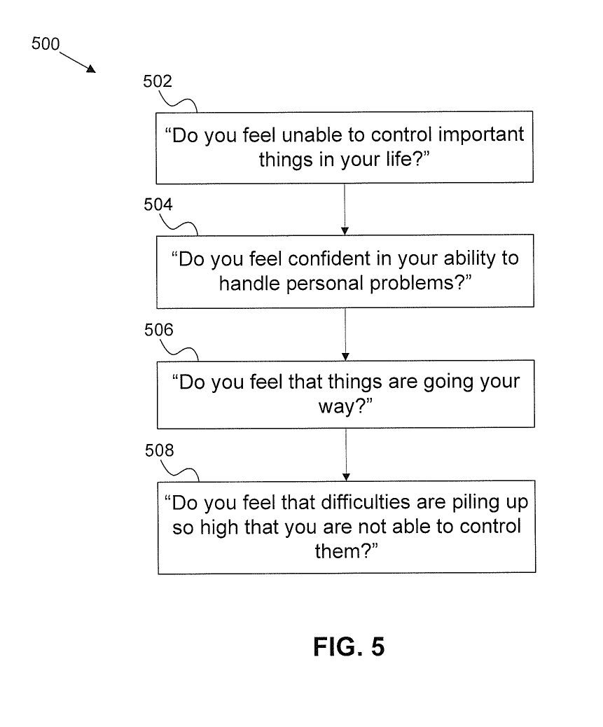

At 312, the user is asked to describe his or her perceived level of stress. This question 312 may be presented as a single, open-ended question or it may be presented as a series of questions, such as the questions 500 of FIG. 5, described below, which are directed toward obtaining from the user specific information pertaining to the user's perceived level of stress.

FIG. 4 illustrates a second example of a sequence of questions 400 presented to a user in accordance with certain embodiments of the disclosed technology. In embodiments where the questions 300 of FIG. 3 are presented to the user by an electronic device, the questions 400 of FIG. 4 may be presented to the user by the same electronic device or another electronic device. The questions 400 of FIG. 4 may be presented in conjunction with or in place of the question presented at 308 of FIG. 3. As discussed above with respect to the questions 300 of FIG. 3, any or all of the questions 400 of FIG. 4 may be presented and in virtually any order. Also, additional questions not specifically listed may also be presented to the user.

At 402, the user is asked to provide a number indicating how many cigarettes he or she smokes on a daily basis. At 404, the user is asked to specify a time indicating how soon the user smokes his or her first cigarette of the day after waking. At 406, the user is asked to specify which cigarette would be most difficult for him or her to give up. At 408, the user is asked to indicate whether it would be difficult for him or her to refrain from smoking in places where smoking is prohibited. At 410, the user is asked to indicate whether he or she smokes more frequently toward the beginning or end of the day. At 412, the user is asked whether he or she smokes even if so ill that the user is unable to get out of bed for most of the day.

FIG. 5 illustrates a third example of a sequence of questions 500 presented to a user in accordance with certain embodiments of the disclosed technology. In embodiments where the questions 300 of FIG. 3 are presented to the user by an electronic device, the questions 500 of FIG. 5 may be presented to the user by the same electronic device or another electronic device. The questions 500 of FIG. 5 may be presented in conjunction with or in place of the question presented at 312 of FIG. 3. As discussed above with respect to the questions 300 of FIG. 3 and questions 400 of FIG. 4, any or all of the questions 500 of FIG. 5 may be presented and in virtually any order. Also, additional questions not specifically listed may also be presented to the user.

At 502, the user is asked to indicate whether he or she feels unable to control important things in his or her life. At 504, the user is asked to indicate whether he or she feels confident in terms of his or her ability to handle personal problems. At 506, the user is asked to indicate whether he or she feels that things are going his or her way. At 508, the user is asked whether he or she feels that difficulties are piling up so high that he or she is not able or no longer able to control them.

FIG. 6 illustrates a first example of a machine-implemented method 600 involving an interactive game to be presented to a user by an electronic device in accordance with certain embodiments of the disclosed technology. The interactive game may be presented to the user by an electronic device such as may occur at 212 of FIG. 2.

At 602, the electronic device presents the interactive game to the user. For example, the electronic device may be a mobile electronic device, such as a smartphone, that presents the interactive game to the user by way of a display or screen. At 604, the electronic device presents one or more follow-up questions to the user. For example, the electronic device may ask the user to indicate whether he or she has had a cigarette since the user's last interaction with the game. At 606, the electronic device receives follow-up information from the user in response to the question(s) presented to the user at 604.

At 608, the electronic device provides the user with one or more rewards based on the follow-up information received at 606. For example, the reward may include a virtual badge, one or more icons, or other such tools to enhance the user's online experience. The method 600 may then return to either 602 or 604. This customized experience based on a tailored approach may advantageously provide the user with real-time feedback and acknowledgement of the user's achievements.

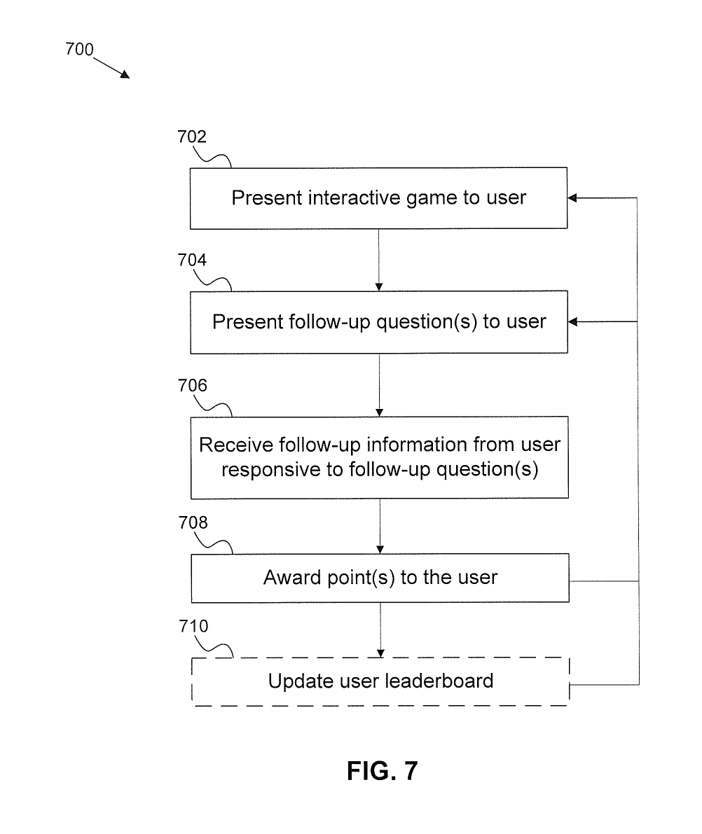

FIG. 7 illustrates a second example of a machine-implemented method 700 involving an interactive game to be presented to a user by an electronic device in accordance with certain embodiments of the disclosed technology. As with the interactive game of FIG. 6, the interactive game of FIG. 7 may be presented to the user by an electronic device such as may occur at 212 of FIG. 2. The operations performed by the electronic device at 702-706 are similar or identical to those performed at 602-606 of FIG. 6, respectively. The interactive game of FIG. 7, however, is based on public commitment to goals by a number of individual participants including the user.

At 708, the electronic device awards one or more points to the user based on the follow-up information received at 706. The point(s) may be granted for providing social support and/or encouragement to others, for example. At 710, the electronic device may optionally update or cause to be updated a leaderboard listing achievements and/or points attributable to the user and, in some embodiments, those of other users as well. In such embodiments, awards correspond to social support as well as individual achievements. In certain embodiments, individual and/or group achievements may be noted at regular intervals. The method 700 may return to 702 or 704 after completion of operations performed at either 708 or 710.

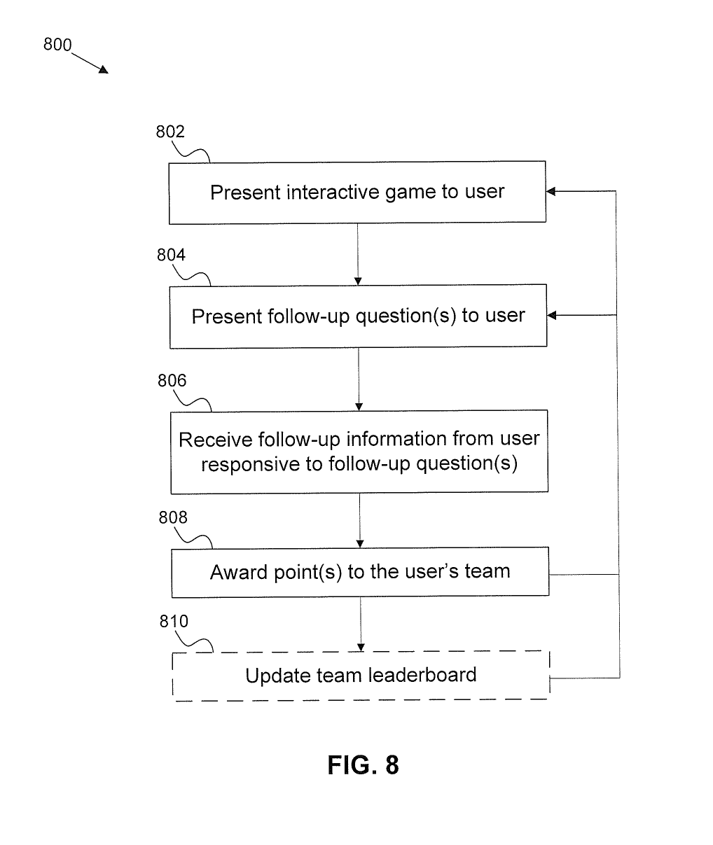

FIG. 8 illustrates a third example of a machine-implemented method 800 involving an interactive game to be presented to a user by an electronic device in accordance with certain embodiments of the disclosed technology. As with either or both of the interactive games of FIGS. 6 and 7, the interactive game of FIG. 8 may be presented to the user by an electronic device such as may occur at 212 of FIG. 2. The operations performed by the electronic device at 802-806 are similar or identical to those performed at 602-606 of FIG. 6, respectively. The interactive game of FIG. 8, however, is based on a team basis. In this method 800, the user is part of a team that may compete against other teams. This team aspect may serve to enhance the success of individual achievement while avoiding conflict by not requiring each team member to perform every task.

At 808, the electronic device awards one or more points to the user's team based on the follow-up information received at 806. The point(s) may be granted for individual achievements and/or cooperative work, for example. At 810, the electronic device may optionally update or cause to be updated a leaderboard listing achievements and/or points attributable to the team and, in some embodiments, those of other participating teams as well. In such embodiments, awards correspond to team leadership as well as achievements. In certain embodiments, team achievements may be noted at regular intervals for the team as a whole. The method 800 may return to 802 or 804 after completion of operations performed at either 808 or 810.

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, communications devices such as cellular phones and smartphones, and the like. These machines may be implemented as part of a cloud computing arrangement.

In certain embodiments, a user location determination mechanism such as a global positioning system (GPS) module, for example, may be used to determine a geographic location of a user. An electronic device may issue an alert to the user based on the determined geographic location. For example, in situations where the system is aware of a user's desire to quit smoking, the electronic device may issue an alert to the user if it is detected that the user has walked into a smoke shop. In other situations where a user is known to want to lose weight or has diabetes, for example, the electronic device may issue an alert to the user if it is detected that the user has walked into a donut shop.

Typically, a machine includes a system bus to which processors, memory (e.g., random access memory (RAM), read-only memory (ROM), and other state-preserving media), storage devices, a video interface, and input/output interface ports can be attached. The machine can also include embedded controllers such as programmable or non-programmable logic devices or arrays, Application Specific Integrated Circuits (ASICs), embedded computers, smart cards, and the like. The machine can be controlled, at least in part, by input from conventional input devices, e.g., keyboards, touch screens, mice, and audio devices such as a microphone, as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short-range or long-range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc., that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible and non-transitory physical storage media. Certain outputs may be in any of a number of different output types such as audio or text-to-speech, for example.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material are intended to be illustrative only, and should not be taken as limiting the scope of the invention. What is claimed as the invention, therefore, is all such modifications as may come within the scope and spirit of the following claims and equivalents thereto.

What is claimed is:

1. A machine-controlled method, comprising:
a mobile electronic device presenting to a user a first plurality of questions, wherein at least one of the first plurality of questions correspond to a first health condition of the user;
the mobile electronic device receiving user input information from the user responsive to the presenting of the first plurality of questions to the user;
a storage device storing the user input information;
a processor determining at least one demographic indicator based at least in part on the user input information;
the processor determining at least one user health behavior indicator based at least in part on the user input information; and
a user interface of the mobile electronic device communicating with the user, wherein the communicating is based at least in part on the at least one demographic indicator and the at least one user health behavior indicator, and wherein the communicating pertains to the first health condition of the user.

2. The machine-controlled method of claim 1, further comprising:
the mobile electronic device presenting at least one follow-up question to the user; and
the mobile electronic device receiving follow-up information from the user responsive to the at least one follow-up question.

3. The machine-controlled method of claim 2, further comprising the processor adaptively updating the communicating based on the follow-up information.

4. The machine-controlled method of claim 2, further comprising the storage device storing the follow-up information.

5. The machine-controlled method of claim 1, wherein the communicating comprises the mobile electronic device presenting an interactive game to the user.

6. The machine-controlled method of claim 3, wherein the communicating comprises the mobile electronic device presenting an interactive game to the user, and wherein adaptively updating the communicating comprises increasing a difficulty level of the interactive game.

7. The machine-controlled method of claim 2, further comprising the mobile electronic device issuing at least one reward to the user based at least in part on the follow-up information.

8. The machine-controlled method of claim 7, wherein the at least one reward comprises at least one of the following:
a point-based reward;
an authorization for a physical reward; and
an authorization for a monetary reward.

9. The machine-controlled method of claim 1, wherein the at least one demographic indicator pertains to at least one of the following:
an age of the user;
a gender of the user;
a body mass index (BMI) of the user;
a waist-to-hip ratio (WHR) of the user;
a Fagerström Tolerance Questionnaire (FTQ) score of the user;
a Fagerström Test for Nicotine Dependence (FTND) score of the user;
an indication as to whether the user lives with or has lived with a smoker; and
an indication of level of education for the user.

10. The machine-controlled method of claim 1, wherein the at least one demographic indicator pertains to test results corresponding to at least one of the following:
at least one biological test performed on the user; and
at least one biochemical test performed on the user.

11. The machine-controlled method of claim 1, wherein the at least one user health behavior indicator pertains to at least one of the following:
user smoking history-related information;
user smoking behavior-related information;
user stress-related information; and
user depression-related information.

12. The machine-controlled method of claim 11, wherein the user smoking behavior-related information pertains to at least one of the following:
a number corresponding to how many cigarettes the user smokes each day;
a measure of duration corresponding to how soon after waking the user has a first cigarette each day;
an indication as to how many cigarettes the user smokes early in the day compared to later in the day;
an indication as to whether the user smokes while ill; and
an indication as to whether the user finds it difficult to not smoke in places where smoking is prohibited.

13. The machine-controlled method of claim 11, wherein the user smoking history-related information pertains to an indication as to whether the user has previously given up smoking.

14. The machine-controlled method of claim 11, wherein the user stress-related information pertains to emotion-related information corresponding to the user.

15. The machine-controlled method of claim 1, wherein at least one of the plurality of questions pertain to physical exercise of the user.

16. The machine-controlled method of claim 1, wherein at least one of the plurality of questions pertain to weight management of the user.

17. The machine-controlled method of claim 1, wherein the mobile electronic device comprises the processor.

18. The machine-controlled method of claim 1, wherein the mobile electronic device comprises one of a group consisting of: a laptop computer, a tablet computing device, and a smartphone.

19. The machine-controlled method of claim 1, wherein the first health condition comprises an undesirable health condition, and wherein the communicating correlates with at least one treatment technique associated with the undesirable health condition.

20. The machine-controlled method of claim 1, further comprising the mobile electronic device presenting to the user a second plurality of questions, wherein at least one of the second plurality of questions correspond to a second health condition of the user, and wherein the user input information received from the user is further responsive to the presenting of the second plurality of questions to the user.

21. The machine-controlled method of claim 20, wherein the communicating further pertains to the second health condition of the user.

22. The machine-controlled method of claim 1, further comprising a user location determination mechanism determining a geographic location of the user, wherein the communicating comprises the mobile electronic device issuing an alert to the user and wherein the communicating is further based at least in part on the geographic location of the user.

23. The machine-controlled method of claim 22, wherein the user location determination mechanism comprises a global positioning system (GPS) module.

24. A system, comprising:
a mobile electronic device configured to:
present a plurality of questions to a user;
receive user input information from the user responsive to the plurality of questions; and
present an interactive game to the user, wherein the interactive game is based on at least one demographic indicator and at least one user health behavior indicator;
a storage device configured to store the user input information; and
a processor configured to:
determine the at least one demographic indicator based at least in part on the user input information; and
determine the at least one user health behavior indicator based at least in part on the user input information.

25. The system of claim 24, wherein the mobile electronic device is further configured to:
present at least one follow-up question to the user; and
receive follow-up information from the user responsive to the at least one follow-up question.

26. The system of claim 25, wherein the mobile electronic device is further configured to adaptively update the interactive game based on the follow-up information.

27. The system of claim 26, wherein the mobile electronic device is configured to adaptively update the interactive game by increasing a difficulty level of the game.

28. The system of claim 26, wherein the mobile electronic device is further configured to issue at least one reward to the user based at least in part on the follow-up information.

29. The system of claim 28, wherein the at least one reward comprises at least one of the following:
a point-based reward;
an authorization for a physical reward; and
an authorization for a monetary reward.

30. The system of claim 25, wherein the storage device is further configured to store the follow-up information.

31. A machine-controlled method, comprising:
an electronic device presenting to a user a plurality of questions, wherein at least one of the plurality of questions corresponds to a health condition of the user;
the electronic device receiving user input information from the user responsive to the presenting of the plurality of questions to the user;
a storage device storing the user input information;
a processor determining at least one demographic indicator based at least in part on the user input information;
the processor determining at least one user health behavior indicator based at least in part on the user input information; and
a user interface of the electronic device presenting an interactive game to the user, wherein the interactive game is based at least in part on the at least one demographic indicator and the at least one user health behavior indicator, and wherein the interactive game pertains to the health condition of the user.

32. The machine-controlled method of claim 31, wherein the electronic device presents the plurality of questions to the user using natural language techniques.

33. The machine-controlled method of claim 31, wherein the user responds to the plurality of questions using natural language techniques.
